(19) United States
(12) Patent Application Publication
(10) Pub. No.: US 2020/0117189 A1
(43) Pub. Date: Apr. 16, 2020

(54) PROBE DATA MANAGEMENT APPARATUS

(71) Applicant: HONDA MOTOR CO., LTD., Minato-ku, Tokyo (JP)

(72) Inventor: Tasuku KAWAI, WAKO-SHI, SAITAMA-KEN (JP)

(21) Appl. No.: 16/332,605

(22) PCT Filed: Jun. 6, 2017
(86) PCT No.: PCT/JP2017/020978

§ 371 Date: Mar. 12, 2019

(30) Foreign Application Priority Data
Sep. 13, 2016 (JP) 2016-178448

(51) Int. Cl. G05D 1/00; B60W 50/08; B60W 50/14; G05D 1/02; G08G 1/0967; G01C 21/34

(52) U.S. Cl. CPC G05D 1/0061; B60W 50/082; G01C 21/3407; G05D 1/0272; G08G 1/096725; B60W 50/14

(57) ABSTRACT

Provided is a probe data management apparatus for enabling a user to get to know in advance a position at which automatic driving is switched to manual driving. When a vehicle has actually travelled by automatic driving, a data acquisition unit acquires probe data indicating the position in which the vehicle travelled by automatic driving and/or the position in which the vehicle did not travel by automatic driving. A communication device transmits the probe data to a probe data server provided outside the vehicle, or to another vehicle

### TECHNICAL FIELD

The present invention relates to a probe data management apparatus that gathers and utilizes probe data of a vehicle capable of travelling with automated driving.

### BACKGROUND ART

Japanese Laid-Open Patent Publication No. 2016-050900 discloses an automated driving support system that transitions from automated driving to manual driving when the conditions for automated driving are difficult. Here, specific examples of conditions where automated driving is difficult include a condition of turning right or left at an intersection, a condition where it is necessary to merge or change the vehicle trajectory in a short distance, and bad weather conditions. According to this automated driving support system, when a vehicle travelling with automated driving approaches an intersection where a right or left turn is expected, for example, guidance prompting manual driving is output from the system side to the driver.

### SUMMARY OF THE INVENTION

A route setting system provided in a vehicle allows the user (including the driver, both here and below) to select a travel route by showing the user travel route candidates, when setting a travel route from a current position to a destination. In such a situation, there are users who desire a travel route in which there are few switches between automated driving and manual driving. Situations in which a switch from automated driving to manual driving occurs include, as disclosed in Japanese Laid-Open Patent Publication No. 2016-050900, a situation of turning right or left at an intersection, a situation where it is necessary to merge or change the trajectory of the vehicle in a short distance, and bad weather conditions, as well as a situation where lane markers disappear or the like.

The location at which switching from automated driving to manual driving occurs can be unpredictable due to bad weather. However, the location of an intersection, a lane change point, or the like can be identified using map information. Therefore, the user can know in advance the position where the switch from automated driving to manual driving will occur, based on an intersection, a lane change point, or the like. On the other hand, due to the disappearance of lane markers, the position where the switch from automated driving to manual driving will occur cannot be identified using map data. Therefore, the user cannot know in advance a location where the switch from automated driving to manual driving will occur due to the disappearance of lane markers.

The present invention takes these problems into consideration, and it is an object of the present invention to provide a probe data management apparatus that enables a user to know in advance a position where the switch from automated driving to manual driving will occur.

The present invention is a probe data management apparatus provided to a vehicle capable of travel with automated driving, comprising a positioning section that measures a current position of the vehicle; an automated driving determining section that determines whether to travel with automated driving at the current position; a data acquiring section that acquires probe data indicating positions travelled through with automated driving and/or positions not travelled through with automated driving, based on a measurement result of the positioning section and a determination result of the automated driving determining section; and a communication medium (communication apparatus) that transmits the probe data to outside the vehicle.

According to the present embodiment, when the vehicle actually travels with automated driving, probe data indicating positions travelled through with automated driving and/or positions not travelled through with automated driving are acquired, and this probe data is transmitted to the outside. Therefore, the probe data indicating positions that can actually be travelled through with automated driving and/or positions that cannot actually be travelled through with automated driving can be shared by each vehicle. Then, by using the shared probe data when generating the travel route candidates, it is possible to know that positions where automated driving is possible and/or the positions where automated driving is not possible, i.e. the hand-over (H/O) request occurrence geographical points here H/O requests for switching from automated driving to manual driving occur.

The probe data management apparatus of the present embodiment further comprises a manual driving requesting section that makes a request for manual driving to a user of the vehicle, if it is determined by the automated driving determining section not to travel with automated driving. The data acquiring section may acquire probe data indicating a geographical point where the request for manual driving occurred. According to the present embodiment, when generating the travel route candidates, it is possible to accurately know the geographical points where H/O requests occur, i.e. the geographical points where a switch from automated driving to manual driving occurs.

The probe data management apparatus may comprise a route generating section that generates travel route candidates of the vehicle, and an information presenting section that presents information to the user, the communication medium may receive the probe data transmitted from outside the vehicle, the route generating section may set a recommendation ranking of the travel route candidates, based on the probe data received by the communication medium, and the information presenting section may present manual driving request information including position information of the geographical point and/or occurrence frequency information of the H/O request occurrence, or the travel route candidates and the recommendation ranking. According to the present embodiment, since the recommendation ranking is set and presented, it is easy for the user to select the travel route candidates.

The data acquiring section may acquire, along with the probe data, weather data and/or timing data at the time when the probe data was acquired, the communication medium may transmit the weather data and/or the timing data tied in with the probe data, when transmitting the probe data to the outside of the vehicle, the communication medium may receive the weather data and/or the timing data tied in with the probe data, when receiving the probe data from the outside of the vehicle, the route generating section may, if the geographical point is included in the travel route candidates, predict weather and/or a timing at the time point when the vehicle passes through the geographical point, and set the recommendation ranking using the probe data in which the weather data and/or the timing data indicating the same state as the predicted weather and/or timing is tied in. According to the present embodiment, since the recommendation ranking is set and presented using pieces of probe data in cases where the weather and/or timing have the same conditions, it is possible to more appropriately set the recommendation ranking.

The data acquiring section may acquire, along with the probe data, reason data indicating a reason that the request occurred, the communication medium may transmit the reason data tied in with the probe data, when transmitting the probe data to the outside of the vehicle, the communication medium may receive the reason data tied in with the probe data, when receiving the probe data from the outside of the vehicle, the route generating section may, if the geographical point is included in the travel route candidates, set the recommendation ranking using the probe data in which a specific piece of reason data is tied in. According to the present embodiment, since the recommendation ranking is set and presented after pieces of probe data are determined to be used or not to be used according to the reason of automated driving being impossible, it is possible to more appropriately set the recommendation ranking.

The data acquiring section may acquire the probe data of a segment through which the automated driving determining section has determined to travel with automated driving. According to the present embodiment, when generating the travel route candidates, it is possible to accurately understand actual data of segments that can be travelled through with automated driving.

The communication medium may transmit only the probe data to a start geographical point of the segment and the probe data at an end geographical point of the segment, as the probe data of the segment to outside the vehicle. According to the present embodiment, since the probe data across the entire segment is not transmitted and only the data indicating the start geographical point and the end geographical point is transmitted, it is possible to reduce the amount of data that is transmitted. As a result, it is possible to reduce the communication load, and to improve the communication speed.

The probe data management apparatus according to the present invention may comprise a manual driving requesting section that makes a request for manual driving to a user of the vehicle, if it is determined by the automated driving determining section not to travel with automated driving; a route generating section that generates travel route candidates of the vehicle; and an information presenting section that presents information to the user. The communication medium may receive the probe data transmitted from outside the vehicle, the route generating section may set a recommendation ranking for the travel route candidates, based on the probe data received by the communication medium, and the information presenting section may present manual driving request information including position information of the end geographical point and/or occurrence frequency information of the request, or the travel route candidates and the recommendation ranking. According to the present embodiment, since the recommendation ranking is set and presented, it is easy for the user to select the travel route candidates.

The data acquiring section may acquire, along with the probe data, weather data and/or timing data at the time when the probe data was acquired, the communication medium may transmit the weather data and/or the timing data tied in with the probe data, when transmitting the probe data to the outside of the vehicle, the communication medium may receive the weather data and/or the timing data tied in with the probe data, when receiving the probe data from the outside of the vehicle, the route generating section may, if a segment is included in the travel route candidates, predict weather and/or a timing at the time point when the vehicle passes through the segment, and set the recommendation ranking using the probe data in which the weather data and/or the timing data indicating the same state as the predicted weather and/or timing is tied in. According to the present embodiment, since the recommendation ranking is set and presented using pieces of probe data in cases where the weather and/or timing have the same conditions, it is possible to more appropriately set the recommendation ranking.

The data acquiring section may acquire, along with the probe data, reason data indicating a reason that the request occurred, the communication medium may transmit the reason data tied in with the probe data, when transmitting the probe data to the outside of the vehicle, the communication medium may receive the reason data tied in with the probe data, when receiving the probe data from the outside of the vehicle, and the route generating section may, if the geographical point is included in the travel route candidates, set the recommendation ranking using the probe data in which a specific piece of reason data is tied in. According to the present embodiment, since the recommendation ranking is set and presented after pieces of probe data are determined to be used or not to be used according to the reason of automated driving being impossible, it is possible to more appropriately set the recommendation ranking.

According to the present invention, probe data indicating positions that can actually be travelled through with automated driving and/or positions that cannot actually be travelled through with automated driving can be shared by each vehicle. Then, by using the shared probe data when generating the travel route candidates, it is possible to know that positions where automated driving is possible and/or the positions where automated driving is not possible.

### BRIEF DESCRIPTION OF DRAWINGS

FIG. 1 is a system configuration diagram of the automated driving management system including the probe data management apparatus according to the present invention;

FIG. 2 is a block diagram of the probe data management apparatus according to the present invention;

FIG. 3 is a flow chart of a data transmission process performed in the first example;

FIG. 4 is a flow chart of a travel route generation process performed in the first example;

FIG. 5 is a diagram showing the travel routes of a vehicle and the H/O request occurrence geographical points in the first example;

FIGS. 6A, 6B, 6C, 6D, 6E and 6F are diagrams showing travel route candidates and geographical points where H/O requests are predicted to occur;

FIG. 7 is a flow chart of a probe data selection process performed in the first example;

FIG. 8 is a flow chart of another probe data selection process performed in the first example;

FIG. 9 is a flow chart of a data transmission process performed by the second example; and

FIG. 10 is a diagram showing the travel routes of a vehicle and the H/O request occurrence geographical points in the second example.

### DESCRIPTION OF EMBODIMENTS

The following describes the present invention while providing examples of preferred embodiments and referencing the accompanying drawings.

### [1. Automated Driving Data Management System 10]

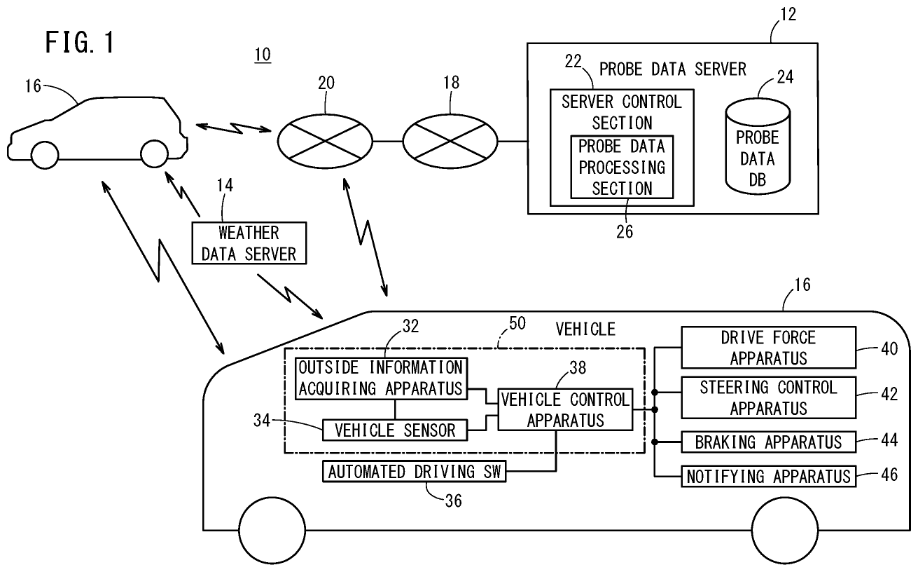

As shown in FIG. 1, the automated driving data management system 10 includes a probe data server 12, a weather data server 14, a plurality of automated driving vehicles 16 (referred to below as “vehicles 16”), a public network 18, and a wireless communication network 20. The probe data server 12 and the vehicles 16 are able to communicate via the public network 18 and the wireless communication network 20. The public network 18 includes telephone lines or the like, for example. The wireless communication network 20 includes a general communication network used by communication terminals such as mobile telephones, or a dedicated communication network or the like used by a road traffic information communication system (Vehicle Information and Communication System, known as

### [2. Prove Data Server 12]

The probe data server 12 is capable of receiving data from the public network 18 and transmitting data to the public network 18, and includes a server control section 22 and a probe data database (DB) 24.

The server control section 22 includes a CPU and a storage apparatus such as a ROM. In the present embodiment, the probe data processing section 26 is realized by the CPU executing a program stored in the ROM. It is also possible to realize the probe data processing section 26 using hardware formed from an integrated circuit and the like.

The probe data processing section 26 receives the probe data transmitted from each vehicle 16, via the wireless communication network 20 and the public network 18, and stores this probe data in the probe data DB 24. Furthermore, the probe data processing section 26 transmits the probe data stored in the probe data DB 24 to each vehicle 16, via the wireless communication network 20 and the public network 18.

### [3. Weather Data Server 14]

The weather data server 14 is provided to broadcast stations in various regions, and performs a service for distributing weather data (including weather information and weather prediction information in each region) using FM broadcasting or the like, for example.

### [4. Vehicle 16]

The vehicle 16 capable of travelling with automated driving receives data from the wireless communication network 20 and transmits data to the wireless communication network 20. The vehicle 16 includes an outside information acquiring apparatus 32, a vehicle sensor 34, an automated driving switch (referred to below as an “automated driving SW 36”), a vehicle control apparatus 38, a drive force apparatus 40, a steering apparatus 42, a braking apparatus 44, and a notifying apparatus 46. The outside information acquiring apparatus 32, the vehicle sensor 34, and the vehicle control apparatus 38 form a probe data management apparatus 50 according to the present embodiment. The probe data management apparatus 50 is described further below (see section [5] below).

The automated driving SW 36 includes a start SW and a stop SW (neither of which are shown in the drawings). The start SW outputs a start signal to the vehicle control apparatus 38, in response to a manipulation by the user. The stop switch outputs a stop signal to the vehicle control apparatus 38, in response to a manipulation by the user.

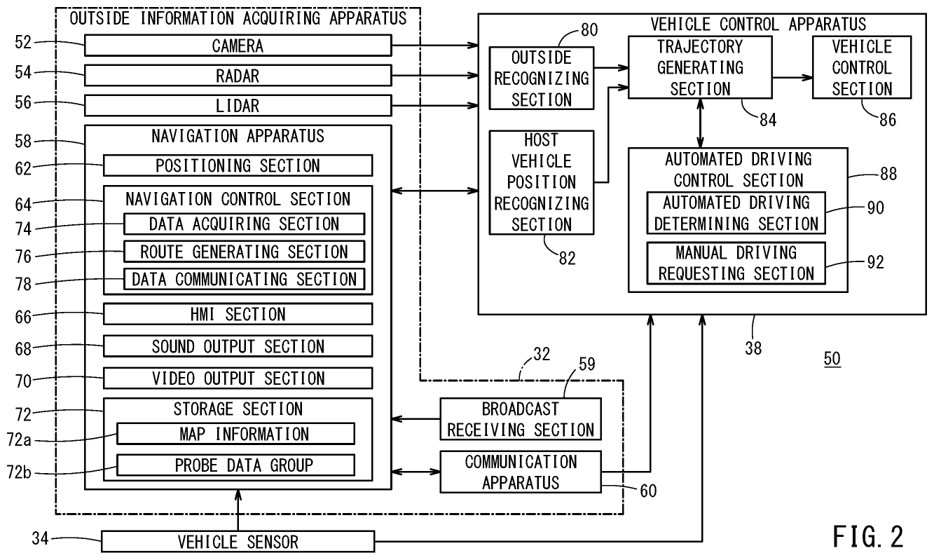

The drive force apparatus 40 includes a drive force ECU and a vehicle 16 drive source such as an engine, drive motor, and/or the like. The drive force apparatus 40 generates a traveling drive force (torque) causing the vehicle 16 to travel according to control instructions output from a vehicle control section 86 (see FIG. 2), and transfers this travelling drive force to the vehicle wheels either via a transmission or directly.

The steering apparatus 42 includes an EPS (Electric Power Steering) system ECU and an EPS apparatus. The steering apparatus 42 changes the direction of the vehicle wheels (steered wheels) according to control instructions output from the vehicle control section 86 (see FIG. 2).

The braking apparatus 44 is an electric servo brake also using a hydraulic brake, and includes a brake ECU and a brake actuator. The braking apparatus 44 brakes the vehicle wheels according to control instructions output from the vehicle control section 86 (see FIG. 2).

The torque distribution and braking force distribution to the right and left wheels can also be changed for the steered wheels of the vehicle 16.

The notifying apparatus 46 includes a notification ECU and a display apparatus and/or a sound apparatus. The notifying apparatus 46 provides notification of a request for manual driving, a procedure for starting manual driving, or the like, according to notification instructions output from a manual driving requesting section 92 (see FIG. 2). The request for manual driving is referred to as an H/O (handover) request.

### [5. Probe Data Management Apparatus 50]

As shown in FIG. 2, the probe data management apparatus 50 includes the outside information acquiring apparatus 32, the vehicle sensor 34, and the vehicle control apparatus 38.

[5-1. Outside information Acquiring Apparatus 32]

The outside information acquiring apparatus 32 includes a plurality of cameras 52, a plurality of radars 54, a plurality of LIDARs, a navigation apparatus 58, a broadcast receiving section 59, and a communication apparatus 60. The cameras 52 capture images around the vehicle 16 to acquire image information. The radars 54 radiate electromagnetic waves around the vehicle 16, and detect reflected waves resulting from the radiation of electromagnetic waves. The LIDARs 56 radiate lasers around the vehicle 16 and detect the scattered light resulting from the radiation of the lasers. It is also possible to use fusion sensors that fuse together the image information acquired by the cameras 52 and the detection information acquired by the radars 54.

The navigation apparatus 58 includes a positioning section 62, a navigation control section 64, an HMI section 66, a sound output section 68, a video output section 70, and a storage section 72. The positioning section 62 measures the current position of the vehicle 16, by using a receiver of a satellite positioning system or by using a gyro sensor and an acceleration sensor (included in the vehicle sensor 34).

The navigation control section 64 includes a CPU and a storage apparatus such as a ROM. In the present embodiment, a data acquiring section 74, a route generating section 76, and a data communicating section 78 are realized by the CPU executing a program stored in the ROM. The data acquiring section 74, the route generating section 76, and the data communicating section 78 can also be realized by hardware formed from an integrated circuit and the like.

The data acquiring section 74 acquires probe data, weather data, and timing data of the vehicle 16. The probe data of the present embodiment includes actual data from the automated driving, in addition to other data indicating the travel route (travel position) of the vehicle 16, vehicle operation (acceleration, braking, steering, and the like), and vehicle behavior (speed, acceleration, deceleration, yaw rate, and the like). The actual data from the automated driving refers to data indicating positions actually travelled through during automated driving, positions not travelled through during the automated driving, and/or the like. The data indicating positions actually travelled through during automated driving is data indicating segments from a geographical start point to a geographical end point of the automated driving. This data may be tied together with data at each geographical point at a plurality of positions included in the segments, or may be tied together with only the data at the geographical start point and geographical end point of a segment. The data indicating positions not travelled through during the automated driving is data indicating geographical points where an H/O request occurred, such as an intersection where the vehicle 16 turned right or left, a geographical point where the lane markers disappeared, a geographical point where an unexpected event (such as the rapid approach of another vehicle) occurred, and the like. Flag data indicating that an H/O request has occurred and reason data indicating the reason that the H/O request occurred are tied together with the data indicating the geographical points where H/O requests occurred. The data acquiring section 74 acquires the probe data from the positioning section 62 and the vehicle sensor 34, acquires the weather data from the weather data server 14, and acquires the timing data from a system date.

The route generating section 76 generates travel route candidates from the current position of the vehicle 16 to a destination set by the user, based on map information 72a 0and a probe data group 72b stored in the storage section 72. Furthermore, the travel routes are set automatically or manually. Yet further, the route generating section 76 predicts a timing at which the vehicle 16 will travel through each position in the travel route candidates.

The data communicating section 78 manages the weather data received by the broadcast receiving section 59 and the probe data transmitted and received by the communication apparatus 60. The data communicating section 78 transmits the probe data, the weather data, and the timing data acquired by the data acquiring section 74 to the probe data server 12 side, periodically or at a specified time, via the communication apparatus 60. Furthermore, the data communicating section 78 receives the probe data transmitted from the probe data server 12, periodically or at a specified time, via the communication apparatus 60, and adds this probe data to the probe data group 72b of the storage section 72, i.e. updates the probe data group 72b.

The HMI section 66 includes buttons, a remote control, a touch panel, or the like, to input the manipulation made by a user. The sound output section 68 includes an amplifier, a speaker, or the like, to output various types of information to be provided to the user as audio. The video output section 70 includes a display or the like, to output various types of information to be provided to the user as video.

The storage section 72 stores the map information 72a and the probe data group 72b. The probe data group 72b is formed by accumulating pieces of probe data transmitted from the probe data server 12, and includes data indicating the positions of segments where automated driving was possible in each region and/or the positions of geographical points where automated driving was impossible (geographical points where an H/O request occurred). Weather data and/or timing data at the timing when the probe data was acquired is tied in with the data at each position. Furthermore, reason data indicating the reason that the H/O request occurred is tied in with the probe data indicating the geographical point where the H/O request occurred. Yet further, in a case where there are a plurality of pieces of probe data at the same position, data indicating the number of times that the probe data was acquired at this position is also tied in.

The broadcast receiving section 59 includes an FM receiver, for example, and receives the weather data distributed by the weather data server 14. The communication apparatus 60 includes a communication terminal or a terminal for VICS (Registered Trademark), and is capable of communicating with the probe data server 12 via the wireless communication network 20 and the public network 18. Furthermore, it is possible to include a communication apparatus 60 that is capable of performing short-range wireless communication (Bluetooth (Registered Trademark) or the like) with other vehicles 16. The communication apparatus 60 may be installed in advance in the vehicle 16, or may be suitably brought into the vehicle 16 from the outside, such as in the case of a mobile terminal (smart phone, tablet terminal, or the like). The communication apparatus 60 is connected in a wired or wireless manner to the navigation apparatus 58 in a manner enabling communication.

### [5-2. Vehicle Sensor 34]

The vehicle sensor 34 includes a plurality of sensors that detect various behaviors of the vehicle 16. For example, the vehicle sensor 34 includes a velocity sensor that detects the velocity (vehicle speed) V of the vehicle 16, an acceleration sensor that detects the acceleration A of the vehicle 16, a lateral G sensor that detects the lateral acceleration G of the vehicle 16, a yaw rate sensor that detects the yaw rate Y of the vehicle 16, an orientation sensor that detects the orientation of the vehicle 16, a gradient sensor that detects the gradient of the vehicle 16, and the like.

The vehicle sensor 34 includes manipulation detection sensors that detect the presence of manipulations, manipulation amounts, and manipulation positions of each operation device (the acceleration pedal, steering wheel, brake pedal, shift lever, direction instructing lever, and the like). For example, the vehicle sensor 34 includes an acceleration pedal sensor for detecting an accelerator depression (opening) amount, a steering angle sensor for detecting an operation amount (steering angle Os) of the steering wheel, a torque sensor for detecting a steering torque Tr, a brake pedal sensor for detecting a brake depression amount, a shift sensor for detecting a shift position, and the like.

### [5-3. Vehicle Control Apparatus 38]

The vehicle control apparatus 38 is formed by one or more ECUs, and includes a CPU and a storage apparatus such as a ROM. In the present invention, each function realization section 80, 82, 84, 86, and 88 is realized by the CPU executing a program stored in the ROM. Instead, each function realization section 80, 82, 84, 86 and 88 can be realized by hardware made from an integrated circuit or the like.

The outdoor recognizing section 80 recognize objects to be recognized such as lane markers, stop lines, roadside objects (guardrail pillars, curbs, and the like), traffic signals, and road signs, as well as the positions of these objects, based on image information acquired mainly by the cameras 52. At this time, image processing is performed, for example. The lane markers can also be recognized from the detection results of the LIDARs 56. Furthermore, based on the detection information acquired mainly by the radars 54 and the LIDARs 56, the outdoor recognizing section 80 recognizes objects to be recognized such as nearby vehicles, pedestrians, and obstructions, and also recognizes the positions, relative velocities, and movement directions of these objects.

The present vehicle position recognizing section 82 recognizes the current position and posture of the vehicle 16, based on the position information of the vehicle 16 measured by the navigation apparatus 58. Separately from this, it is possible for the current position of the vehicle 16 to be measured using detection information of the satellite positioning apparatus, the vehicle sensor 34, and the like and to recognize the current position and the posture of the vehicle 16, without using the navigation apparatus 58.

The trajectory generating section 84 generates a target travel route and a target velocity for the vehicle 16, based on the recognition result of the outdoor recognizing section 80 and the recognition result of the present vehicle position recognizing section 82, to enable the vehicle 16 to travel along the travel route generated by the navigation apparatus 58. When generating the target travel route that is straight ahead, the substantial center between lane markers on both sides recognized by the outdoor recognizing section 80 is set as a target position.

The vehicle control section 86 outputs control instructions to the drive force apparatus 40, the steering apparatus 42, and the braking apparatus 44 shown in FIG. 1. During automated driving, the vehicle control section 86 outputs control instructions that cause the vehicle 16 to travel with the target velocity along the target travel route generated by the trajectory generating section 84, and during manual driving, the vehicle control section 86 outputs control instructions based on the detection results of the manipulation detection sensors (the acceleration pedal sensor, the steering angle sensor, the brake pedal sensor, and the like).

The automated driving control section 88 performs integrated control of the automated driving. The automated driving control section 88 includes an automated driving determining section 90 and a manual driving requesting section 92. The automated driving determining section 90 determines whether travel with automated driving is to be performed at the current position of the vehicle 16 recognized by the present vehicle position recognizing section 82. If the trajectory generating section 84 can set the target route trajectory, e.g. if the lane markers can be recognized by the outdoor recognizing section 80, the automated driving determining section 90 determines that travel with automated driving is possible. On the other hand, if the trajectory generating section 84 cannot set the target route trajectory during automated driving, e.g. if the lane markers cannot be recognized by the outdoor recognizing section 80, the automated driving determining section 90 determines that travel with automated driving is impossible. Furthermore, if the vehicle 16 is making a right or left turn at an intersection, the automated driving determining section 90 determines that travel with automated driving is impossible. Yet further, if another vehicle is recognized as approaching by the outdoor recognizing section 80, the automated driving determining section 90 determines that travel with automated driving is impossible. If the automated driving determining section 90 has determined that travel with automated driving is impossible, the manual driving requesting section 92 makes a request for manual driving to the driver. At this time, the manual driving requesting section 92 outputs notification instructions to the notifying apparatus 46.

The automated driving control section 88 starts the automated driving in response to a start signal output from the start SW of the automated driving SW 36 (see FIG. 1), and stops the automated driving in response to a stop signal output from the stop SW. Furthermore, the automated driving control section 88 stops the automated driving if manual manipulation of any one of the operation devices is recognized during the automated driving. The automated driving control section 88 then starts (restarts) the automated driving if prescribed conditions are established after passing through an intersection.

### [6. Operation of the Probe Data Management Apparatus 50]

The probe data management apparatus 50 acquires the probe data and transmits the acquired probe data to the probe data server 12, either periodically or at a specified timing, while the vehicle 16 is travelling with automated driving (data transmission process). Furthermore, the probe data management apparatus 50 receives from the probe data server 12 the probe data acquired by each vehicle 16, either periodically or at a specified timing. When the navigation apparatus 58 is manipulated to input a destination, travel route candidates from the current position of the vehicle 16 to the destination are generated (travel route generation process). The following describes the data transmission process and the travel route generation process using two examples (a first example and a second example). The first example is an embodiment acquiring probe data at geographical points not travelled through with automated driving, and the second example is an embodiment acquiring probe data of segments travelled through with automated driving.

### [6-1. First Example]

### [6-1-1. Data Transmission Process]

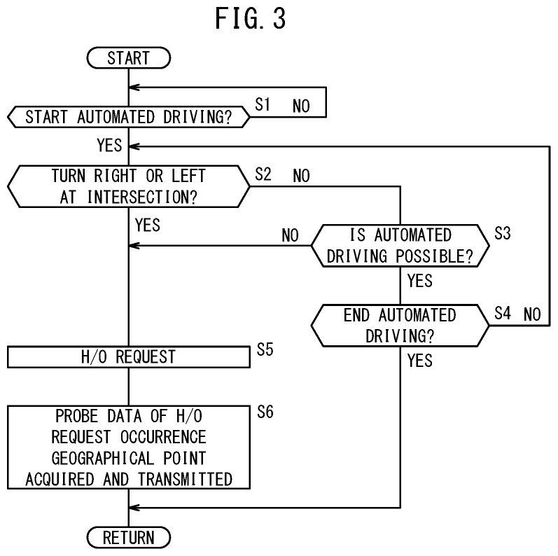

The following describes the data transmission process of the first example, using the flow chart shown in FIG. 3. The series of processes described below is performed by the probe data management apparatus 50 every certain unit of time.

At step S1, the automated driving control section 88 determines whether to start the automated driving. If the start SW of the automated driving SW 36 is manipulated and the state is such that automated driving can be performed, the automated driving is started. In this case (step S1: YES), the process transitions to step S2. On the other hand, if the automated driving is not started, e.g. if manual driving is being performed (step S1: NO), the determination of step S1 is repeated.

At step S2, the present vehicle position recognizing section 82 determines whether the vehicle 16 is to make a right or left turn at an intersection, based on the current position of the vehicle 16 and the travel route output from the navigation apparatus 58. If a right or left turn is to be made (step S2: YES), the process transitions to step S5. At this time, the automated driving determining section 90 determines that travel with automated driving is impossible. On the other hand, if a right or left turn is not to be made (step S2: NO), the process transitions to step S3.

When the process has transitioned from step S2 to step S3, the automated driving determining section 90 determines whether travel with automated driving is possible. If it is possible to detect lane markers with the outdoor recognizing section 80 and no other approaching vehicles 16 are recognized, for example, the automated driving determining section 90 determines that travel with automated driving is possible. In this case (step S3: YES), the process transitions to step S4. On the other hand, if lane markers cannot be recognized by the outdoor recognizing section 80 or if another approaching vehicle 16 is recognized, for example, the automated driving determining section 90 determines that travel with automated driving is impossible. In this case (step S3: NO), the process transitions to step S5.

When the process has transitioned from step S3 to step S4, the automated driving control section 88 determines whether the automated driving has ended. The automatic driving ends when an end SW of the automated driving SW 36 is manipulated or when an operation device is manipulated. If the automated driving has ended (step S4: YES), the data transmission process also ends for now. On the other hand, if the automated driving has not ended (step S4: NO), the process returns to step S2.

When the process has transitioned from step S2 or step S3 to step S5, the manual driving requesting section 92 makes a manual driving request (H/O request). At this time, the manual driving requesting section 92 outputs the notification instructions to the notifying apparatus 46. The notifying apparatus 46 prompts the driver to perform manual driving, with a display or audio.

At step S6, the data acquiring section 74 of the navigation apparatus 58 acquires the probe data of the geographical point where the H/O request was made, at the timing when the H/O request was made. At this time, the data acquiring section 74 acquires the reason data indicating the reason that the H/O request was made from the manual driving requesting section 92, e.g. a flag 1 in the case of a right or left turn at an intersection, a flag 2 in the case of lane markers disappearing, a flag 3 in the case of another vehicle approaching, and the like. Furthermore, the data acquiring section 74 acquires weather data and timing data along with the above data. The data communicating section 78 creates communication data in which the probe data, the reason data, the weather data, the timing data, and other necessary data are tied together with a vehicle identification number (VIN), for example, and transmits this communication data to the probe data server 12 via the communication apparatus 60. At this point, the data transmission process is ended for now.

### [6-1-2. Travel Route Generation Process]

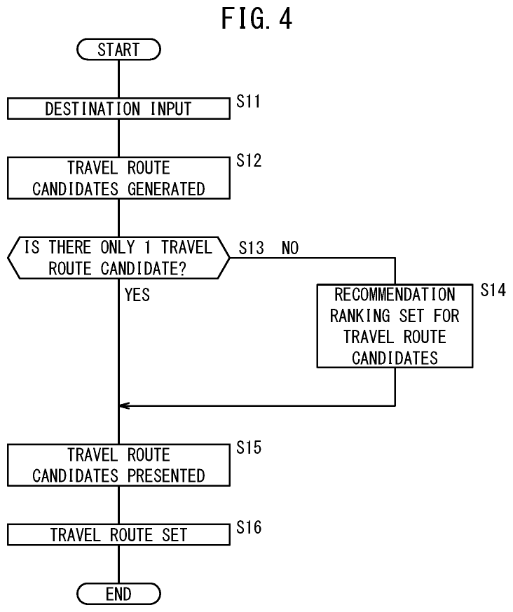

The following describes the travel route generation process of the first example, using the flow chart shown in FIG. 4. The series of processes described below are performed when the user sets the destination for automated driving by manipulating the HMI section 66 of the navigation apparatus 58.

At step S11, the destination is input via the HMI section 66. At step S12, the route generating section 76 generates travel route candidates based on the map information 72a and the probe data group 72b stored in the storage section 72. For example, the route generating section 76 generates the travel route candidates having the shortest travel distances or shortest travel times from the current position of the vehicle 16 to the destination.

At step S13, the route generating section 76 determines whether there are one or more travel route candidates. If there is one travel route candidate, the process transitions to step S15. If there are a plurality of travel route candidates, the process transitions to step S14.

At step S14, the route generating section 76 sets a recommendation ranking for the plurality of travel route candidates. In the present embodiment, the method for setting the recommendation ranking is to give a higher recommendation ranking to travel route candidates for which the number of H/O requests is lower. Specifically, a higher recommendation ranking is given to travel route candidates for which the total of the number of intersections where a right or left turn is predicted included in the travel route candidate and the number of geographical points other than intersections where an H/O request is to be made is lower. The number of geographical points where an H/O request is to be made included in each travel route candidate is acquired from the probe data group 72b. The details of the setting of the recommendation ranking are described further below (see section [6-1-3] below).

At step S15, the route generating section 76 presents the travel route candidates to the user. Here, the travel route candidates are displayed by the video output section 70, and audio guidance concerning the travel route candidates is provided by the sound output section 68. If there are a plurality of travel route candidates, a prescribed number of travel route candidates at the top of the recommendation ranking are presented. At this time, recommendation ranking information may also be presented, such that the user can understand the recommendation ranking.

At step S16, when the user manipulates the HMI section 66 to select one travel route candidate, the route generating section 76 sets this travel route candidate as the travel route. At this time, the route generating section 76 may set the travel route candidate that is highest in the recommendation ranking as the travel route. At this point, the travel route generation process ends.

### [6-1-3. Travel Route Candidate Generation Process]

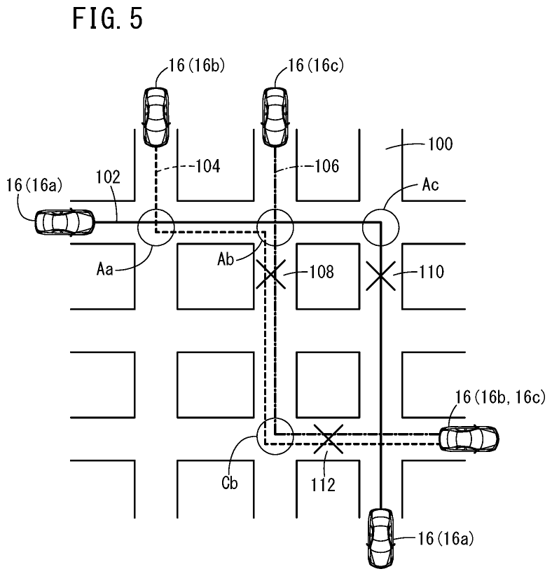

The following describes a detailed example of the processes of step S12 and step S14 shown in FIG. 4. First, as shown in FIG. 5, when the vehicle 16 (either the present vehicle or another vehicle) travels on the travel path 100 with automated driving, the probe data transmitted from each vehicle 16 is stored in the probe data server 12 (see FIG. 1). Here, it is assumed that probe data transmitted when a vehicle 16a travelled on a travel route 102, probe data transmitted when a vehicle 16b travelled on a travel route 104, and probe data transmitted when a vehicle 16c travelled on a travel route 106 are saved in the probe data server 12. Data indicating an intersection Ac that is a geographical point where an H/O request is made and a travelled geographical point 110 is included in the probe data of the travel route 102, as actual data from automated driving. Furthermore, data indicating intersections Aa, Ab, and Cb that are geographical points where an H/O request is made and travelled geographical points 108 and 112 is included in the probe data of the travel route 104, as actual data from automated driving. Yet further, data indicating an intersection Cb that is a geographical point where an H/O request is made and travelled geographical points 108 and 112 is included in the probe data of the travel route 106, as actual data from automated driving. These pieces of probe data are transmitted from the probe data server 12 to each vehicle 16, and stored in each storage section 72 as a probe data group 72b.

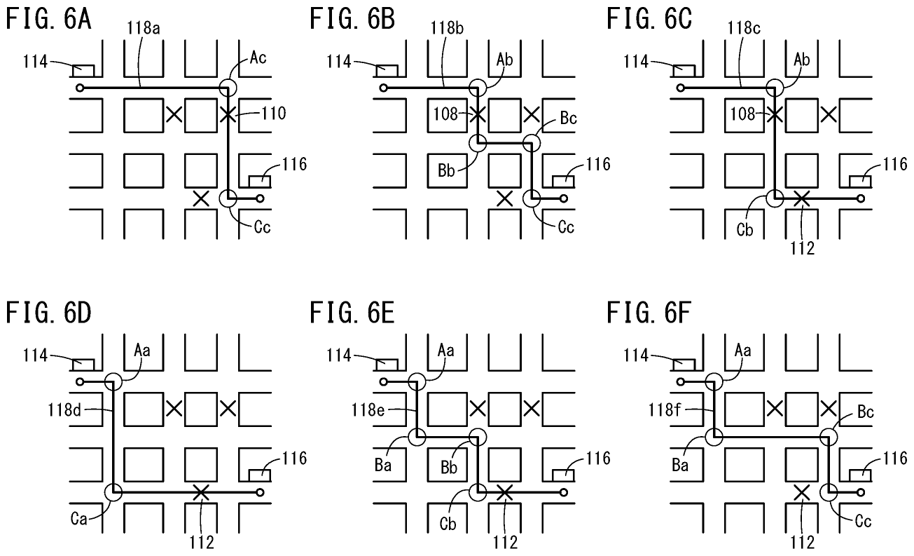

Next, as shown in FIGS. 6A to 6F, when the vehicle 16 stops at the current position 114, the user manipulates the HMI section 66 to set the destination 116. The route generating section 76 generates travel route candidates 118a to 118f from the current position 114 to the destination 116. At this time, the route generating section 76 predicts the number of occurrences and the occurrence positions of H/O requests in each of the travel route candidates 118a to 118f, based on the probe data group 72b of the storage section 72.

For the travel route candidate 118a, H/O requests are predicted to occur at three geographical points, which are the intersections Ac and Cc and the travelled geographical point 110. For the travel route candidate 118b, H/O requests are predicted to occur at five geographical points, which are the intersections Ab, Bb, Bc, and Cc and the travelled geographical point 108. For the travel route candidate 118c, H/O requests are predicted to occur at four geographical points, which are the intersections Ab and Cb and the travelled geographical points 108 and 112. For the travel route candidate 118d, H/O requests are predicted to occur at three geographical points, which are the intersections Aa and Ca and the travelled geographical point 112. For the travel route candidate 118e, H/O requests are predicted to occur at five geographical points, which are the intersections Aa, Ba, Bb, and Cb and the travelled geographical point 112. For the travel route candidate 118f, H/O requests are predicted to occur at four geographical points, which are the intersections Aa, Ba, Bc, ad Cc. Among these travel route candidates, the travel route candidates 118a and 118d have the lowest predicted number of H/O request occurrences.

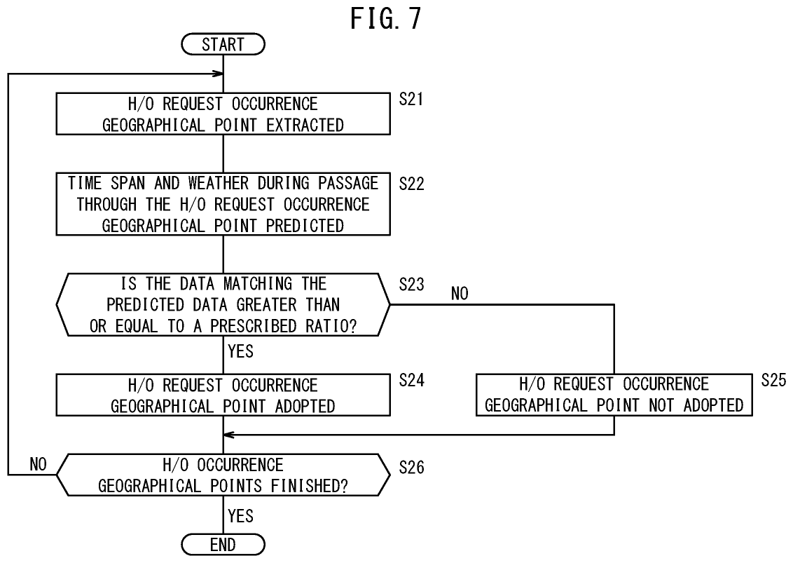

In this way, if the number of H/O request occurrences is the same for a plurality of travel route candidates 118a and 118d, the recommendation ranking is determined with further conditions. In the present embodiment, in order to determine the recommendation ranking, the probe data selection process shown in FIG. 7 is further performed to select the probe data to be used. The probe data selection process shown in FIG. 7 is performed separately for each of the travel route candidates 118a and 118d.

At step S21, the route generating section 76 extracts one request occurrence geographical point (excluding intersections) from among the one or more H/O request occurrence geographical points included in the travel route candidate 118a (or the travel route candidate 118d). One or more pieces of weather data and timing data are tied into the probe data of the extracted H/O request occurrence geographical point. At step S22, the route generating section 76 predicts the time period during which the H/O request occurrence geographical point will be passed through and the weather during this time period. The weather data distributed by the weather data server 14 is used for the weather.

At step S23, the route generating section 76 determines whether the amount of data matching the data predicted at step S22 (weather and time period) is greater than or equal to a prescribed ratio among the one or more pieces of weather data and timing data acquired at step S21. For example, assume that the predicted weather data is “clear” and the timing data is “12:00 to 13:00”. Furthermore, assume that there are two sets of acquired data, the weather data is “cloudy” and the timing data is “14:10” in the first set, and the weather data is “clear” and the timing data is “12:30” in the second set. In this case, it is determined that the second set of data matches the predicted data. Then, since one set between these two sets matches the predicted data, the ratio is determined to be “50%”. If this ratio is greater than or equal to the prescribed ratio (step S23: YES), the process transitions to step S24. On the other hand, if the ratio is less than the prescribed ratio (step S23: NO), the process transitions to step S25.

At step S24, the route generating section 76 adopts the H/O request occurrence geographical point extracted at step S21. At step S25, the route generating section 76 does not adopt the H/O request occurrence geographical point extracted at step S21.

At step S26, a determination is made as to whether there are any more H/O request occurrence geographic points (excluding the intersections) included in the travel route candidate 118a (or the travel route candidate 118d). If the processes of step S22 to step S24 or step S25 have been performed for all of the H/O request occurrence geographical points excluding the intersections (step S26: YES), the probe data selection process ends. On the other hand, if there is an H/O request occurrence geographical point for which the processes of step S22 to step S24 or step S25 have not been performed (step S26: NO), the process returns to step S21.

For example, assume that the travelled geographical point 110 included in the travel route candidate 118a shown in FIG. 6A is adopted at step S24 and that the travelled geographical point 112 included in the travel route candidate 118d shown in FIG. 6D is not adopted at step S25. In this case, for the travel route candidate 118a, H/O requests are predicted to occur at three geographical points, which are the intersections Ac and Cc and the travelled geographical point 110. For the travel route candidate 118d, H/O requests are predicted to occur at two geographical points, which are the intersections Aa and Ca. Accordingly, the travel route candidate 118d has the lowest number of predicted H/O request occurrences.

From the processes described above, the recommendation ranking order, from the highest, is determined to be the travel route candidate 118d, the travel route candidate 118a, the travel route candidate 118c or the travel route candidate 118f, and the travel route candidate 118b or the travel route candidate 118e. Among these, the travel route candidate 118d and the travel route candidate 118a, which are the two highest ranked, are presented to the user. The presentation method uses the video output section 70, for example. The video output section 70 displays the travel route candidate 118d and the travel route candidate 118a superimposed on the map from the current position 114 to the destination 116. At this time, the travel route candidate 118d is shown by a solid line, and the travel route candidate 118a is shown by a dashed line. Alternatively, the travel route candidate 118d and the travel route candidate 118a are shown with different colors from each other. The travel route candidate 118d and the travel route candidate 118a may be shown by character information. The H/O request occurrence geographical points and/or the occurrence frequency (number of occurrences) at these geographical points may be shown. Furthermore, the character information may be changed into audio information and output by the sound output section 68.

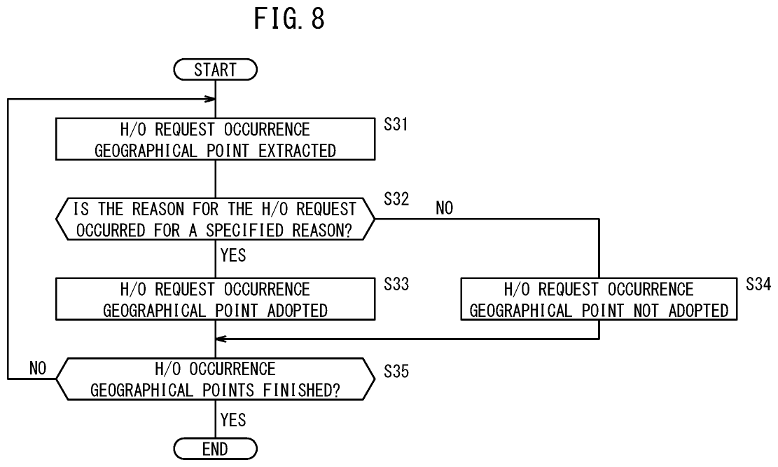

Instead of the probe data selection process shown in FIG. 7, the probe data selection process shown in FIG. 8 may be performed. Some of the processes in the probe data selection process shown in FIG. 8 match processes in the probe data selection process shown in FIG. 7. Specifically, the processes of step S33 to step S35 match the processes of step S24 to step S26. The descriptions of matching processes are omitted.

At S31, the route generating section 76 extracts one geographical point from among the one or more H/O request occurrence geographical points included in the travel route candidate 118a (or the travel route candidate 118d). Reason data is tied into the probe data of the extracted H/O request occurrence geographical point.

At step S32, the route generating section 76 determines whether the reason for the H/O request occurrence at the H/O request occurrence geographical point is a specified reason. Assume that in the reason data, a flag 1 is set in the case of a right or left turn at an intersection, a flag 2 is set in the case of the lane markers disappearing, and a flag 3 is set in the case of another vehicle approaching. Among these flags, flag 1 occurs permanently and flag 2 occurs frequently or semi-frequently, while flag 3 has a high probability of occurring intermittently. In this way, in the case of a specified reason (flag 1 or 2) (step S32: YES), the process transitions to step S33. On the other hand, in a case where the reason is not a specified reason (flag 1 or 2) (step S32: NO), the process transitions to step S34. Then, the H/O request occurrence geographical point is adopted or not adopted at step S33 or step S34.

### [6-2. Second Example]

### [6-2-1. Data Transmission Process]

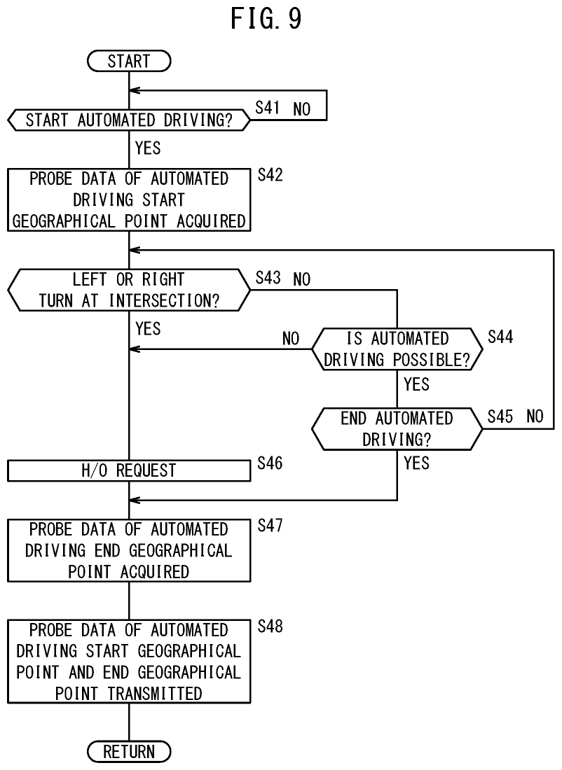

The following describes the data transmission process of the second example, using the flow chart shown in FIG. 9. The series of processes described below is performed by the probe data management apparatus 50 every certain unit of time.

At step S41, the automated driving control section 88 determines whether to start the automated driving. If the start SW of the automated driving SW 36 is manipulated and the state is such that automated driving can be performed, the automated driving is started. In this case (step S41: YES), the process transitions to step S42. On the other hand, if the automated driving is not started, e.g. if manual driving is being performed (step S41: NO), the determination of step S41 is repeated.

At step S42, the data acquiring section 74 of the navigation apparatus 58 acquires the probe data of the automated driving start geographical point, at the timing when the automated driving was started. At this time, the data acquiring section 74 acquires the weather data and timing data along with the above data. The data communicating section 78 creates automated driving start data in which the probe data, the weather data, the timing data, and other necessary data at the automated driving start geographical point are tied together with a vehicle identification number (VIN), for example, and temporarily accumulates this data in the storage section 72. At this stage, the communication data may be transmitted to the probe data server 12 via the communication apparatus 60.

At step S43, the present vehicle position recognizing section 82 determines whether the vehicle 16 is to make a right or left turn at an intersection, based on the current position of the vehicle 16 and the travel route output from the navigation apparatus 58. If a right or left turn is to be made (step S43: YES), the process transitions to step S46. At this time, the automated driving determining section 90 determines that travel with automated driving is impossible. On the other hand, if a right or left turn is not to be made (step S43: NO), the process transitions to step S44.

When the process has transitioned from step S43 to step S44, the automated driving determining section 90 determines whether travel with automated driving is possible. If it is possible to detect lane markers with the outdoor recognizing section 80 and no other approaching vehicles 16 are recognized, for example, the automated driving determining section 90 determines that travel with automated driving is possible. In this case (step S44: YES), the process transitions to step S45. On the other hand, if lane markers cannot be recognized by the outdoor recognizing section 80 or if another approaching vehicle is recognized, for example, the automated driving determining section 90 determines that travel with automated driving is impossible. In this case (step S44: NO), the process transitions to step S46.

When the process has transitioned from step S44 to step S45, the automated driving control section 88 determines whether the automated driving has ended. The automatic driving ends when an end SW of the automated driving SW 36 is manipulated or when an operation device is manipulated. If the automated driving has ended (step S45: YES), the process transitions to step S47. On the other hand, if the automated driving has not ended (step S45: NO), the process returns to step S43.

When the process has transitioned from step S43 or step S44 to step S46, the manual driving requesting section 92 makes a manual driving request (H/O request). At this time, the manual driving requesting section 92 outputs the notification instructions to the notifying apparatus 46. The notifying apparatus 46 prompts the driver to perform manual driving, with a display or audio.

When the process has transitioned from step S45 or step S46 to step S47, the data acquiring section 74 of the navigation apparatus 58 acquires the probe data of an automated driving end geographical point, at the timing when the automated driving ends. At this time, the data acquiring section 74 acquires the reason data (including the reason that the H/O request occurred) indicating the reason that the automated driving ended from the manual driving requesting section 92, e.g. a flag 1 in the case of a right or left turn at an intersection, a flag 2 in the case of lane markers disappearing, a flag 3 in the case of another vehicle approaching, a flag 4 in the case of the end SW or an operation device being manipulated, and the like. Furthermore, the data acquiring section 74 acquires weather data and timing data along with the above data. The data communicating section 78 creates the automated driving end data in which the probe data, the reason data, the weather data, the timing data, and other necessary data of the automated driving end geographical point are tied together with a vehicle identification number (VIN) or the like, for example.

At step S48, the data communicating section 78 transmits the probe data of the automated driving start geographical point and the automated driving end geographical point to the probe data server 12 via the communication apparatus 60. At this point, the data transmission process ends for now.

### [6-2-2. Travel Route Generation Process]

In the second example as well, it is possible to use the travel route generation process of the first example shown in FIG. 4. However, although the H/O request occurrence geographical points are used in the first example, the automated driving end geographical points are used instead in the second embodiment.

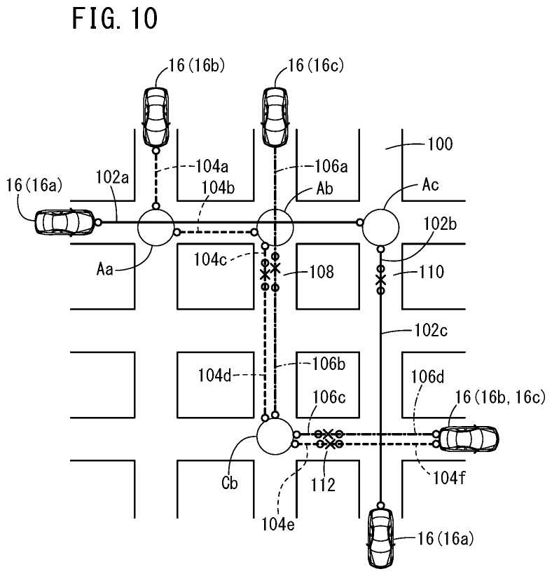

The acquisition of data in the case of the second example is described using the same travel state as each vehicle 16 shown in FIG. 4. First, as shown in FIG. 10, when the vehicle 16 (either the present vehicle or another vehicle) travels on the travel path 100 with automated driving, the probe data transmitted from each vehicle 16 is stored in the probe data server 12 (see FIG. 1). Here, it is assumed that probe data transmitted when a vehicle 16a travelled on travel routes 102a to 102c, probe data transmitted when a vehicle 16b travelled on travel route 104a to 104f, and probe data transmitted when a vehicle 16c travelled on travel route 106a to 106d are saved in the probe data server 12. Data indicating each segment of the travel routes 102a to 102c, which is data indicating the automated driving start geographical point and the automated driving end geographical point of each segment, is included in each piece of probe data of the travel routes 102a to 102c, as actual data from automated driving. Data indicating each segment of the travel routes 104a to 104f, which is data indicating the automated driving start geographical point and the automated driving end geographical point of each segment, is included in each piece of probe data of the travel routes 104a to 104f, as actual data from automated driving. Data indicating each segment of the travel routes 106a to 106d, which is data indicating the automated driving start geographical point and the automated driving end geographical point of each segment, is included in each piece of probe data of the travel routes 106a to 106d, as actual data from automated driving. These pieces of probe data are transmitted from the probe data server 12 to each vehicle 16, and saved as the probe data group 72b in each storage section 72.

In the second example as well, it is possible to use the probe data selection process shown in FIG. 7 and FIG. 8. However, when determining the geographical points at which H/O requests occurred in each step, the process is performed using the automated driving end geographical points as the geographical points where the H/O requests occurred.

### [7. Modifications]

In the present embodiment, the probe data is transmitted and received between the vehicle 16 and the probe data server 12, but the transmitting and receiving of the probe data may be performed using vehicle-to-vehicle communication, i.e. between the vehicles 16.

### [8. Summarization of the Present Embodiment]

The probe data management apparatus 50 according to the present embodiment comprises a positioning section 62 that measures a current position of the vehicle 16; an automated driving determining section 90 that determines whether to travel with automated driving at the current position; a data acquiring section 74 that acquires probe data indicating positions travelled through with automated driving and/or positions not travelled through with automated driving, based on a measurement result of the positioning section 62 and a determination result of the automated driving determining section 90; and a communication apparatus 60 (communication medium) that transmits the probe data to outside the vehicle 16.

According to the present embodiment, when the vehicle 16 actually travels with automated driving, probe data indicating positions travelled through with automated driving and/or positions not travelled through with automated driving are acquired, and this probe data is transmitted to the outside. Therefore, the probe data indicating positions that can actually be travelled through with automated driving and/or positions that cannot actually be travelled through with automated driving can be shared by each vehicle 16. Then, by using the shared probe data when generating the travel route candidates 118a to 118f, it is possible to know that positions where automated driving is possible and/or the positions where automated driving is not possible, i.e. the H/O request occurrence geographical points here H/O requests for switching from automated driving to manual driving occur.

### [8-1. Summarization of the First Example]

The probe data management apparatus 50 shown in the first example further comprises a manual driving requesting section 92 that makes a request for manual driving to a user of the vehicle 16, if it is determined by the automated driving determining section 90 not to travel with automated driving. The data acquiring section 74 acquires probe data indicating a geographical point where the request for manual driving occurred. According to the present embodiment, when generating the travel route candidates 118a to 118f, it is possible to accurately know the geographical points where H/O requests occur, i.e. the geographical points where a switch from automated driving to manual driving occurs.

The probe data management apparatus 50 comprises a route generating section 76 that generates travel route candidates 118a to 118f of the vehicle 16, and a sound output section 68 (information presenting section) that presents information to the user. The communication medium 60 receives the probe data transmitted from outside the vehicle 16 (the probe data server 12 or another vehicle 16). The route generating section 76 sets a recommendation ranking of the travel route candidates 118a to 118f, based on the probe data received by the communication apparatus 60. The video output section 70 and the sound output section 68 present manual driving request information including position information of the geographical point and/or occurrence frequency information of the H/O request occurrence, or the travel route candidates 118a to 118f and the recommendation ranking. According to the present embodiment, since the recommendation ranking is set and presented, it is easy for the user to select the travel route candidates 118a to 118f.

The data acquiring section 74 acquires, along with the probe data, weather data and/or timing data at the time when the probe data was acquired. The communication apparatus 60 transmits the weather data and/or the timing data tied in with the probe data, when transmitting the probe data to the outside of the vehicle 16. The communication apparatus 60 receives the weather data and/or the timing data tied in with the probe data, when receiving the probe data from the outside of the vehicle 16. The route generating section 76, if the geographical point is included in the travel route candidates 118a to 118f, predicts weather and/or a timing at the time point when the vehicle 16 passes through the geographical point, and sets the recommendation ranking using the probe data in which the weather data and/or the timing data indicating the same state as the predicted weather and/or timing is tied in. According to the present embodiment, since the recommendation ranking is set and presented using pieces of probe data in cases where the weather and/or timing have the same conditions, it is possible to more appropriately set the recommendation ranking.

The data acquiring section 74 acquires, along with the probe data, reason data indicating a reason that the request occurred. The communication apparatus 60 transmits the reason data tied in with the probe data, when transmitting the probe data to the outside of the vehicle 16. The communication apparatus 60 receives the reason data tied in with the probe data, when receiving the probe data from the outside of the vehicle 16. The route generating section 76, if the geographical point is included in the travel route candidates 118a to 118f, sets the recommendation ranking using the probe data in which a specific piece of reason data is tied in. According to the present embodiment, since the recommendation ranking is set and presented after pieces of probe data are determined to be used or not to be used according to the reason of automated driving being impossible, it is possible to more appropriately set the recommendation ranking.

### [8-2. Summarization of the Second Example]

In the probe data management apparatus 50 according to the second example, the data acquiring section 74 acquires the probe data of a segment through which the automated driving determining section 90 has determined to travel with automated driving. According to the present embodiment, when generating the travel route candidates, it is possible to accurately understand actual data of segments that can be travelled through with automated driving.

The communication apparatus 60 transmits only the probe data to a start geographical point of the segment and the probe data at an end geographical point of the segment, as the probe data of the segment to outside the vehicle 16. According to the present embodiment, since the probe data across the entire segment is not transmitted and only the data indicating the start geographical point and the end geographical point is transmitted, it is possible to reduce the amount of data that is transmitted. As a result, it is possible to reduce the communication load, and to improve the communication speed.

The probe data management apparatus 50 according to comprises a manual driving requesting section 92 that makes a request for manual driving to a user of the vehicle 16, if it is determined by the automated driving determining section 90 not to travel with automated driving; a route generating section 76 that generates travel route candidates 118a to 118f of the vehicle 16; and a video output section 70 and a sound output section 68 (information presenting sections) that present information to the user. The communication apparatus 60 receives the probe data transmitted from outside the vehicle 16 (the probe data server 12 or another vehicle 16). The route generating section 76 sets a recommendation ranking for the travel route candidates 118a to 118f, based on the probe data received by the communication apparatus 60. The video output section 70 and the sound output section 68 present manual driving request information including position information of the end geographical point and/or occurrence frequency information of the request, or the travel route candidates 118a to 118f and the recommendation ranking. According to the present embodiment, since the recommendation ranking is set and presented, it is easy for the user to select the travel route candidates 118a to 118f.

The data acquiring section 74 acquires, along with the probe data, weather data and/or timing data at the time when the probe data was acquired. The communication apparatus 60 transmits the weather data and/or the timing data tied in with the probe data, when transmitting the probe data to the outside of the vehicle 16. The communication apparatus 60 receives the weather data and/or the timing data tied in with the probe data, when receiving the probe data from the outside of the vehicle 16. The route generating section 76, if a segment is included in the travel route candidates 118a to 118f, predicts weather and/or a timing at the time point when the vehicle 16 passes through the segment (e.g. an end geographical point), and sets the recommendation ranking using the probe data in which the weather data and/or the timing data indicating the same state as the predicted weather and/or timing is tied in. According to the present embodiment, since the recommendation ranking is set and presented using pieces of probe data in cases where the weather and/or timing have the same conditions, it is possible to more appropriately set the recommendation ranking.

The data acquiring section 74 acquires, along with the probe data, reason data indicating a reason that the request occurred. The communication apparatus 60 transmits the reason data tied in with the probe data, when transmitting the probe data to the outside of the vehicle 16. The communication apparatus 60 receives the reason data tied in with the probe data, when receiving the probe data from the outside of the vehicle 16. The route generating section 76, if the geographical point is included in the travel route candidates 118a to 118f, sets the recommendation ranking using the probe data in which a specific piece of reason data is tied in. According to the present embodiment, since the recommendation ranking is set and presented after pieces of probe data are determined to be used or not to be used according to the reason of automated driving being impossible, it is possible to more appropriately set the recommendation ranking.

1. A probe data management apparatus provided to a vehicle capable of traveling with automated driving, comprising:
a positioning section configured to measure a current position of the vehicle;
an automated driving determining section configured to determine whether to travel with automated driving at a current position;
a data acquiring section configured to acquire probe data indicating positions travelled through with automated driving and/or positions not travelled through with automated driving, based on a measurement result of the positioning section and a determination result of the automated driving determining section; and
a communication medium configured to transmit the probe data to outside the vehicle.

2. The probe data management apparatus according to claim 1, further comprising:
a manual driving requesting section configured to make a request for manual driving to a user of the vehicle, if it is determined by the automated driving determining section not to travel with automated driving, wherein
the data acquiring section acquires probe data indicating a geographical point where the request for manual driving occurred.

3. The probe data management apparatus according to claim 2, comprising:
a route generating section configured to generate travel route candidates of the vehicle; and
an information presenting section configured to present information to a user, wherein
the communication medium receives the probe data transmitted from outside the vehicle,
the route generating section sets a recommendation ranking of the travel route candidates, based on the probe data received by the communication medium, and
the information presenting section presents manual driving request information including position information of the geographical point and/or occurrence frequency information of the request, or the travel route candidates and the recommendation ranking.

4. The probe data management apparatus according to claim 3, wherein
the data acquiring section acquires, along with the probe data, weather data and/or timing data at a time when the probe data was acquired,
the communication medium transmits the weather data and/or the timing data tied in with the probe data, when transmitting the probe data to the outside of the vehicle, and receives the weather data and/or the timing data tied in with the probe data, when receiving the probe data from the outside of the vehicle, and
the route generating section, if the geographical point is included in the travel route candidates, predicts weather and/or a timing at a time point when the vehicle passes through the geographical point, and sets the recommendation ranking using the probe data in which the weather data and/or the timing data indicating the same state as the predicted weather and/or timing is tied in.

5. The probe data management apparatus according to claim 3, wherein
the data acquiring section acquires, along with the probe data, reason data indicating a reason that the request occurred,
the communication medium transmits the reason data tied in with the probe data, when transmitting the probe data to the outside of the vehicle, and receives the reason data tied in with the probe data, when receiving the probe data from the outside of the vehicle, and
the route generating section, if the geographical point is included in the travel route candidates, sets the recommendation ranking using the probe data in which a specific piece of reason data is tied in.

6. The probe data management apparatus according to claim 1, wherein
the data acquiring section acquires the probe data of a segment through which the automated driving determining section has determined to travel with automated driving.

7. The probe data management apparatus according to claim 6, wherein
the communication medium transmits only the probe data to a start geographical point of the segment and the probe data at an end geographical point of the segment, as the probe data of the segment to outside the vehicle.

8. The probe data management apparatus according to claim 7, comprising:
a manual driving requesting section configured to make a request for manual driving to a user of the vehicle, if it is determined by the automated driving determining section not to travel with automated driving;
a route generating section configured to generate travel route candidates of the vehicle; and
an information presenting section configured to present information to the user, wherein
the communication medium receives the probe data transmitted from outside the vehicle,
the route generating section sets a recommendation ranking for the travel route candidates, based on the probe data received by the communication medium, and
the information presenting section presents manual driving request information including position information of the end geographical point and/or occurrence frequency information of the request, or the travel route candidates and the recommendation ranking.

9. The probe data management apparatus according to claim 8, wherein
the data acquiring section acquires, along with the probe data, weather data and/or timing data at the time when the probe data was acquired,
the communication medium transmits the weather data and/or the timing data tied in with the probe data, when transmitting the probe data to the outside of the vehicle, and receives the weather data and/or the timing data tied in with the probe data, when receiving the probe data from the outside of the vehicle, and
the route generating section, if the geographical point is included in the travel route candidates, predicts weather and/or a timing at a time point when the vehicle passes through the geographical point, and sets the recommendation ranking using the probe data in which the weather data and/or the timing data indicating the same state as the predicted weather and/or timing is tied in.

10. The probe data management apparatus according to claim 8, wherein
the data acquiring section acquires, along with the probe data, reason data indicating a reason that the request occurred,
the communication medium transmits the reason data tied in with the probe data, when transmitting the probe data to the outside of the vehicle, and receives the reason data tied in with the probe data, when receiving the probe data from the outside of the vehicle, and
the route generating section, if the geographical point is included in the travel route candidates, sets the recommendation ranking using the probe data in which a specific piece of reason data is tied in.
